(19) United States
(12) Patent Application Publication
(10) Pub. No.: US 2026/0343206 A1
(43) Pub. Date: Oct. 29, 2026

(54) SIM PROFILE SWITCH

(71) Applicant: QUALCOMM Incorporated, San Diego, CA (US)

(72) Inventors: Gunbir SINGH, Hyderabad (IN); Raghuveer Ramakrishna Srinivas TARIMALA, Hyderabad (IN); Amrit KUMAR, Hyderabad (IN); Sohrab AHMAD, Hyderabad (IN); Rohit HILL, Ghumarwin (IN); Ravi BALAGANI, Hyderabad (IN); Srinivasarao PASUMARTHI, Hyderabad (IN); Rishika TINDOLA, Hyderabad (IN)

(21) Appl. No.: 19/187,935

(22) Filed: Apr. 23, 2025

(51) Int. Cl. H04W 8/18; H04W 60/04; H04W 84/04

(52) U.S. Cl. CPC H04W 8/183; H04W 60/04; H04W 84/042

(57) ABSTRACT

Apparatus, methods, and computer program products for wireless communication are provided. An example method may include receiving, from a lower layer, a set of MCCs currently associated with the UE. The example method may further include switching from a first SIM profile to a second SIM profile or remaining on the first SIM profile based on the set of MCCs. The example method may further include communicating with a network node based on the first SIM profile or the second SIM profile.

### TECHNICAL FIELD

The present disclosure relates generally to communication systems, and more particularly, to wireless communication systems with subscriber identity module (SIM) profile switch.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDM A) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include at least one memory and at least one processor coupled to the at least one memory. Based at least in part on information stored in the at least one memory, the at least one processor, individually or in any combination, is configured to (e.g., cause the UE to) receive, from a lower layer, a set of mobile country codes (MCCs) currently associated with the UE. Based at least in part on information stored in the at least one memory, the at least one processor, individually or in any combination, is configured to switch from a first subscriber identity module (SIM) profile to a second SIM profile or remain on the first SIM profile based on the set of MCCs.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network, in accordance with various aspects of the present disclosure.

FIG. 4A is a diagram illustrating example procedures for subscriber identity module (SIM) switch, in accordance with various aspects of the present disclosure.

FIG. 4B is a diagram illustrating example procedures for SIM switch where mobile country code (MCC) based rules may be used, in accordance with various aspects of the present disclosure.

FIG. 5 is a diagram illustrating example procedures for SIM switch where mobile country code (MCC) based rules may be used, in accordance with various aspects of the present disclosure.

FIG. 6 is a diagram illustrating example procedures for SIM switch where different radio access technologies (RATs) may have different priorities, in accordance with various aspects of the present disclosure.

FIG. 7 is a diagram illustrating example procedures for SIM switch where different RATs may have different priorities, in accordance with various aspects of the present disclosure.

FIG. 8 is a diagram illustrating example procedures for SIM switch where different RATs may have different priorities, in accordance with various aspects of the present disclosure.

FIG. 9 is a diagram illustrating example communications between a network node and a UE, in accordance with various aspects of the present disclosure.

FIG. 10 is a flowchart of a method of wireless communication, in accordance with various aspects of the present disclosure.

FIG. 11 is a flowchart of a method of wireless communication, in accordance with various aspects of the present disclosure.

FIG. 12 is a diagram illustrating an example of a hardware implementation for an example apparatus and/or network entity, in accordance with various aspects of the present disclosure.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

In some wireless communication systems, the subscriber identity module (SIM) profile switch may be triggered whenever there is no service, which may be power draining for devices (e.g., trackers) in some regions. For example, in North America (NA), there may be support for European union (EU)1 without support for EU2, which means that a device with EU1 and EU2 attempting to switch SIM profile between EU1 and EU2 to cause power drain without additional benefit. Additionally, in some wireless communication systems, if a temporary network rejection associated with one profile happens at a given time in a day, the profile switch may not be triggered again for an extended duration (e.g., within the same day) even if there is service available for another radio access technology (RAT) in the same profile, which may lead to data transmission being stopped for a longer duration that may be shortened. Aspects provided herein provide mechanisms for SIM profile switching that may improve operation of a wireless device in some conditions, e.g., such as a device that may be travelling for a long distance.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof. One or more processors in the processing system may execute software to cause a device that includes the one or more processors to perform the various functionality described throughout this disclosure.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer (e.g., transitory or non-transitory medium that may be accessed by computer).

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B, evolved NB (eNB), NRBS, 5G Node B, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

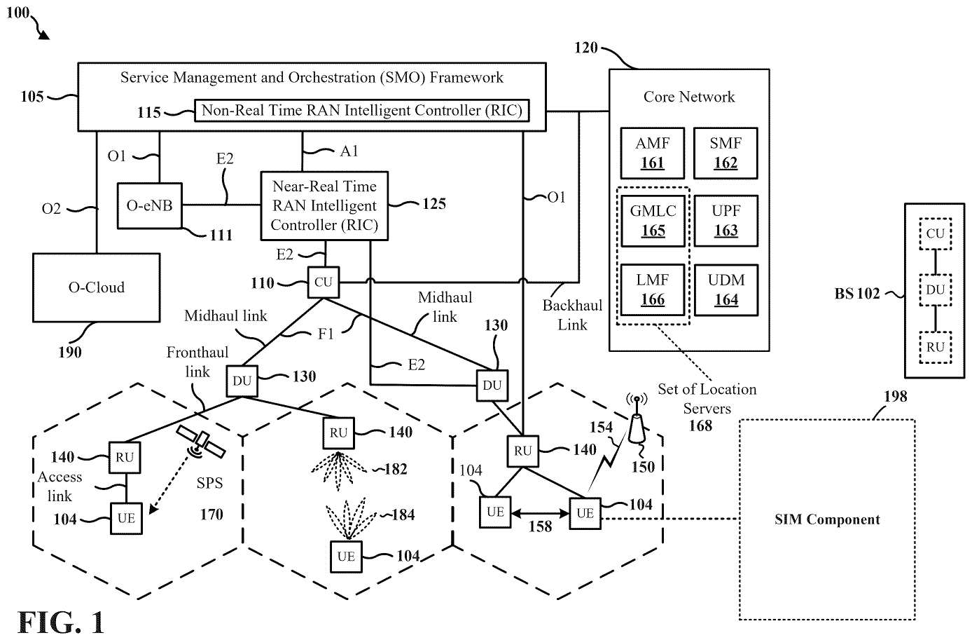

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Y× MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell). Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GH z-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The A M F 161 is the control node that processes the signaling between the UEs 104 and the core network 120. The AM F 161 supports registration management, connection management, mobility management, and other functions. The SM F 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GM LC 165, the LMF 166, a position determination entity (PDE), a serving mobile location center (SMLC), a mobile positioning center (MPC), or the like. The GM LC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a SIM component 198. In some aspects, the SIM component 198 may be configured to receive, from a lower layer, a set of mobile country codes (MCCs) currently associated with the UE. In some aspects, the SIM component 198 may be further configured to switch from a first SIM profile to a second SIM profile or remain on the first SIM profile based on the set of MCCs.

Although the following description may be focused on 5G NR, the concepts described herein may be applicable to other similar areas, such as 6G, LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

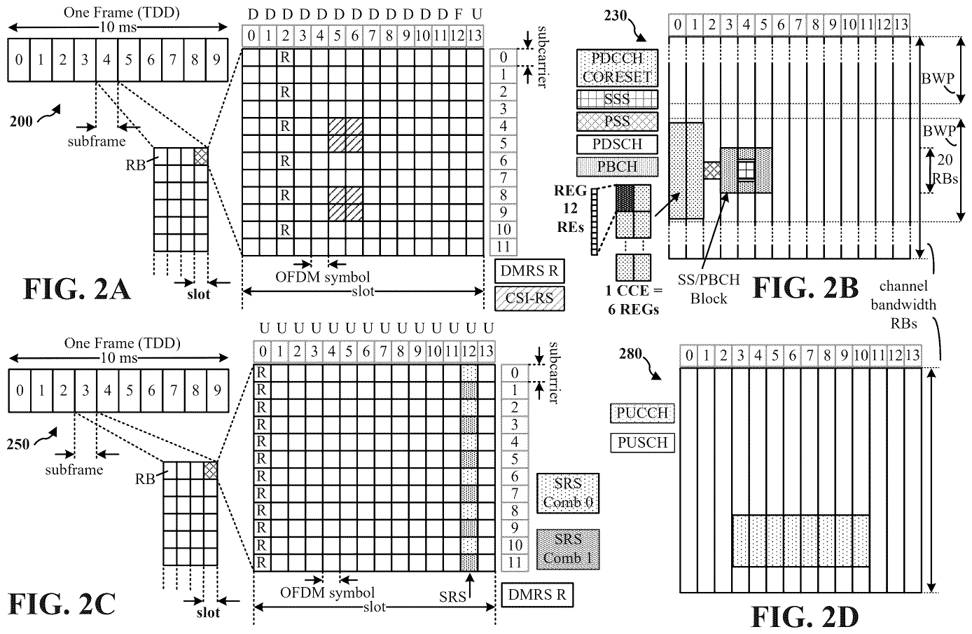

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 KHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

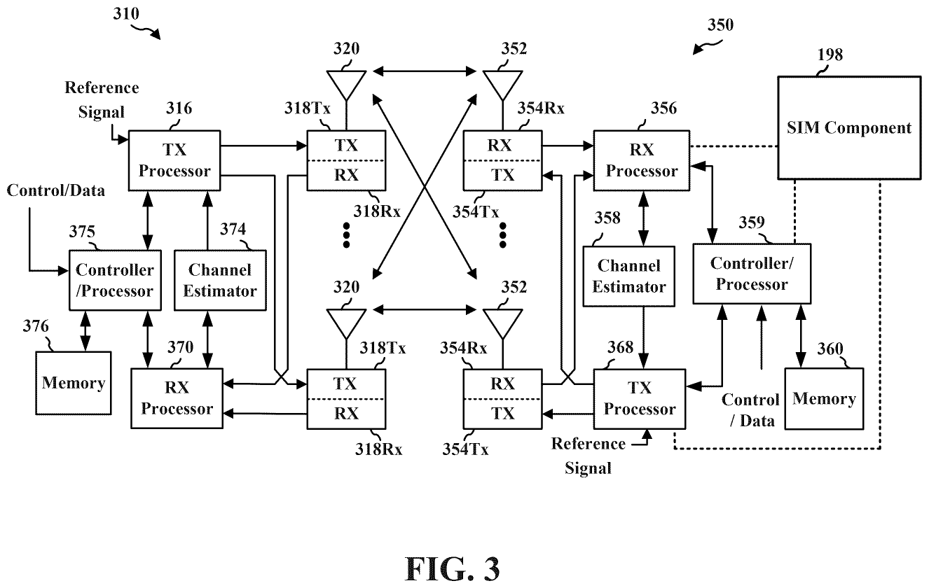

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (iFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PD Us, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with SIM component 198 of FIG. 1.

The evolution of SIM technology has transitioned from SIM cards (universal integrated circuit cards) to embedded SIMs (eUICC) and integrated SIMs (iSIM), which may increase flexibility in managing mobile network operator (MNO) profiles. A SIM card may store a single MNO profile, including the international mobile subscriber identity (IMSI), operator preferred public land mobile networks (OPLMNs), authentication keys, and applets, with a memory capacity of 64 or 128 kilobytes. In some aspects, a user may manually replace a SIM card to switch MNOs. Additionally, global roaming may not be feasible with a single profile due to the presence of over 800 MNOs worldwide. The introduction of embedded SIM s (eUICC) allows multiple MNO profiles to be stored on a single device. These SIM s operate within a standardized framework that supports over-the-air (OTA) provisioning and management of profiles, enabling users to switch MNOs without physically changing the SIM card. With a minimum memory of 512 kilobytes, eUICC SIM s offer greater flexibility. However, eUICC may not be ideal for machine-to-machine (M2M) applications because each MNO switch may use a new service plan or enrollment. While mobile virtual network operators (MVNOs) can address this issue by offering unified services across various MNOs, the profile-switching control may still remain cloud-based. Integrated SIMs (iSIM), combines eU ICC functionality with multi-IMSI capabilities. The iSIMs may come preloaded with multiple IMSI profiles under a single plan or service agreement, facilitating seamless roaming, including satellite connectivity, without using OTA interaction with target MNO infrastructure. Control over switching profiles may move from the cloud to the device itself. The switching decision relies on an IMSI table and predefined switching rules. To facilitate such switch, the IMSI table may be periodically updated by service providers based on new roaming agreements among MNOs.

There may be multiple methods for managing IMSI selection in eSIM-enabled devices. The first method involves embedding the selection intelligence within eSIM applets (e.g., software functionality that enables eSIM). These applets may come preloaded when the eSIM is purchased, and the IMSI switching decision may be based on factors such as the device's service status and location. Such a method may be not tailored to specific scenarios. Additionally, because IMSI switching may occur independently of the device's modem activities, it can lead to asynchronous behavior, and interactions with power-saving mode (PSM) are not possible. The PSM may be a mode where the UE would remain attached to the network but turns off its radio module to save power. The UE may not receive paging messages during PSM but may wake-up periodically or based on an internal event (e.g., sensor trigger) to transmit data. The second method leverages an algorithm provided by a third-party application and may enable the use of more refined and advanced switching rules, with the application operating in higher layers such as the application processor (AP). As a result, network selection performance may improve compared to the first method. However, feature interactions such as power-saving mode, access stratum behaviors, data service (DS) backoffs, packet data network (PDN) rejections, and other network behaviors may not be managed efficiently within the constraints of third-party application software. The third method, integrates the IMSI selection logic directly within the device or modem. The modem management mode (M MODE) and non-access stratum (NAS) may handle IMSI selection, while switching commands interface with the eSIM or trusted execution environment (TEE) SIM. The third method may allow for optimization across different scenarios, including improved support for non-terrestrial network (NTN) connectivity.

For some devices that may travel for a long time, such as IoT devices (e.g., trackers) that may move around the globe, there may be multiple (e.g., two or more) SIM profiles. For example, a first profile may be used for EU1 (coverage-optimized mode) associated with narrowband (NB)-IoT (NB-IoT) with cellular network support (e.g., NB/G radio access technology (RAT)), a second profile may be used for EU2 (standard cellular IoT mode) associated with LTE-M with cellular network support (CA™/G RAT), and a third profile may be used for EU3 associated with NTN. Each of the profiles may support overlapping RATs, but the RAT that may have a higher priority to be used for each profile may be different and the profile that have a higher priority to be used for each RAT may be different. For example, a first SIM profile may have a higher priority to be used for LTE-M and 2G, and a second SIM profile may have a higher priority to be used for NB-IoT. As another example, in a certain region categorized by a particular mobile country code (MCC), LTE-M and 2G may be available via one profile and NB-IoT may be available via a different profile due to a mobile virtual network operator (MVNO) having different roaming agreement with separate network operators where some network operators may provide service over one RAT and other network operators may provide service over other RATs. As another example, the NTN providers may be different than the TN providers and then these providers may not have roaming agreement in place.

In some wireless communication systems, the SIM profile switch may get triggered whenever there is no service, which may be power draining for devices (e.g., trackers) in some regions. For example, in North America (NA), there may be support for EU1 without support for EU2, which means that a device with EU1 and EU2 attempting to switch SIM profile between EU1 and EU2 to cause power drain without additional benefit. Additionally, in some wireless communication systems, if a temporary network reject associated with one profile happens at a given time in a day, the profile switch may not be triggered again for an extended duration (e.g., within the same day) even if there is service available for another RAT in the same profile, which may lead to data transmission being stopped for a longer duration that may be shortened. Aspects provided herein provide mechanisms for SIM profile switching that may be more suited for a device that may be travelling for a long distance.

As an example, in some wireless communication systems, for a particular region (e.g., region A), the coverage may be under EU2 profile (in 2G). When a UE roams into a neighboring region (e.g., region B) of region A, the UE may not switch to a more efficient RAT or associated profile (e.g., such as a profile based on LTE-M network) unless the 2G coverage is out of service (OOS), which may lead to performance degradation. Because information regarding the number of regions where each RAT under each profile may be available or unavailable may be known, to more efficiently perform SIM profile switch, the UE may be configured with (e.g., based on signaling from a network node, or without signaling from the network node and stored at the UE) MCC based rules that maps at least one SIM profile to one or more MCCs or one or more combinations of MCCs (e.g., in the form of a table), where the at least one SIM profile may be switched to (or stayed on) if the mapped MCC(s) are detected. For example, for EU2 profile in 2G, the usage of EU2 profile in 2G may be restrained to one or more particular combinations of MCCs or PLM Ns and the UE may switch to another profile if the UE detects a MCC or public land mobile network (PLMN) (e.g., or a different identifier that may be associated with a region) that may be different from the one or more particular combinations of MCCs or PLMNs. For example, if the UE moved to region B, the UE may switch to EU1 if it detects a non-EU2MCC (e.g., not defined to be associated with the EU1 profile based on the one or more particular combinations of MCCs) in inter-RAT (IRAT) search results. As an example, for EU2, the one or more particular combinations of MCCs or PLM Ns may include combinations of MCCs that provides service based on EU2 without providing service under an EU1 profile as provided in the table below:

TABLE 2
Example MCCs defined to be associated with EU2 profile

| PLMN | MCCMNC | Country |
|---|---|---|
| ANDMA | 21303 | Andorra |
| VGBCW | 348170 | British Virgin Islands |
| ITAWI | 22288 | Italy |
| ITASI | 22201 | Italy |
| ITAOM | 22210 | Italy |
| GBRJT | 23450 | Jersey |
| PLWPC | 55201 | Palau |

As an example, if the UE that originally uses an EU1 profile detects (e.g., determines that the UE is associated with, such as by receiving information from a lower layer based on an IRAT search) an EU2MCC without detecting a non-EU2MCC, the UE may perform a switch from EU1 SIM profile to EU2 SIM profile. If the UE that originally uses an EU1 profile detects (e.g., determines that the UE is associated with, such as by receiving information from a lower layer based on an IRAT search) an EU2MCC and a non-EU2MCC, the UE may stay on a EU1 SIM profile. If a UE that originally uses an EU2 profile detects (e.g., determines that the UE is associated with, such as by receiving information from a lower layer based on an IRAT search) an EU2MCC and a non-EU2MCC, the UE may switch to a EU1 SIM profile. If the UE that originally uses an EU2 profile detects (e.g., determines that the UE is associated with, such as by receiving information from a lower layer based on an IRAT search) a non-EU2MCC without detecting an EU2MCC, the UE may switch to an EU1 SIM profile.

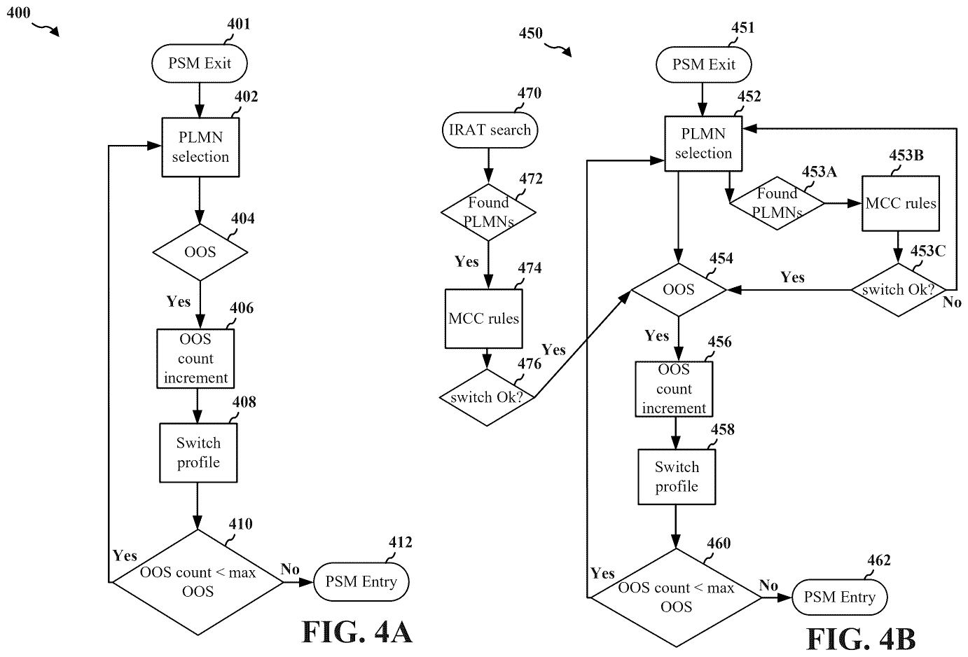

FIG. 4A is a diagram 400 illustrating example procedures for SIM switch, in accordance with various aspects of the present disclosure. As illustrated in FIG. 4A, the UE may exit a power saving mode (PSM) at 401 and may perform PLMN selection at 402. If the UE is out of service at 404, at 406, the UE may increase a OOS counter and perform a SIM switch at 408. If the number of OOS counted based on the OOS counter is smaller than a maximum OOS threshold at 410, the UE may enter PSM at 412. If the number of OOS counted based on the OOS counter is not smaller than a maximum OOS threshold at 410, the UE may (re-)perform PLMN selection (402).

FIG. 4B is a diagram 450 illustrating example procedures for SIM switch where mobile country code (MCC) based rules may be used, in accordance with various aspects of the present disclosure. As illustrated in FIG. 4B, the UE may exit a power saving mode (PSM) at 451 and may perform PLMN selection at 452. If the UE is able to find a PLMN at 453A, at 453B, the UE may check the found PLMN(s) and associated MCCs based on a set of MCC rules to determine whether the UE may switch (e.g., at 453C) the SIM profile. If the UE determines that the UE may switch the SIM profile, the UE may go OOS at 454. If the UE determines that the UE may not switch the SIM profile, the UE may (re-)perform PLM N selection (452). If the UE is not able to find PLMN(s), the UE may be OOS at 454. In some aspects, as a UE performs IRAT search at 470, the UE may determine whether it could find PLM N at 472. If the UE could find PLMN at 472, at 474, the UE may check the found PLM N(s) and associated MCCs based on a set of MCC rules to determine whether the UE may switch (e.g., at 476) the SIM profile. If the UE determines that the UE may switch the SIM profile, the UE may go OOS at 454.

If the UE is out of service at 454, at 456, the UE may increase an OOS counter and perform a SIM switch at 458. If the number of OOS counted based on the OOS counter is smaller than a maximum OOS threshold at 460, the UE may enter PSM at 462. If the number of OOS counted based on the OOS counter is not smaller than a maximum OOS threshold at 460, the UE may (re-)perform PLM N selection (452). In some aspects, the UE may perform full RAT network selection based on an extended OOS condition (e.g., based on the UE being OOS for a period of time longer than a threshold or based on a no-service counter that counts the number of 00S occurrences that may be maintained per SIM profile across PSM s or online cycles). If the extended OOS condition is true, the UE may expand, in a RAT search, the scope of RATs to full RATs. Once the condition is cleared, the RATs may be removed from a list and the default profile RATs may be applied. In some aspects, a PLM N list may be maintained by the UE on a per-SIM profile basis across PSM s so that the UE will not attempt to register on a network (e.g., under a particular RAT) that the UE may not be rejected before.

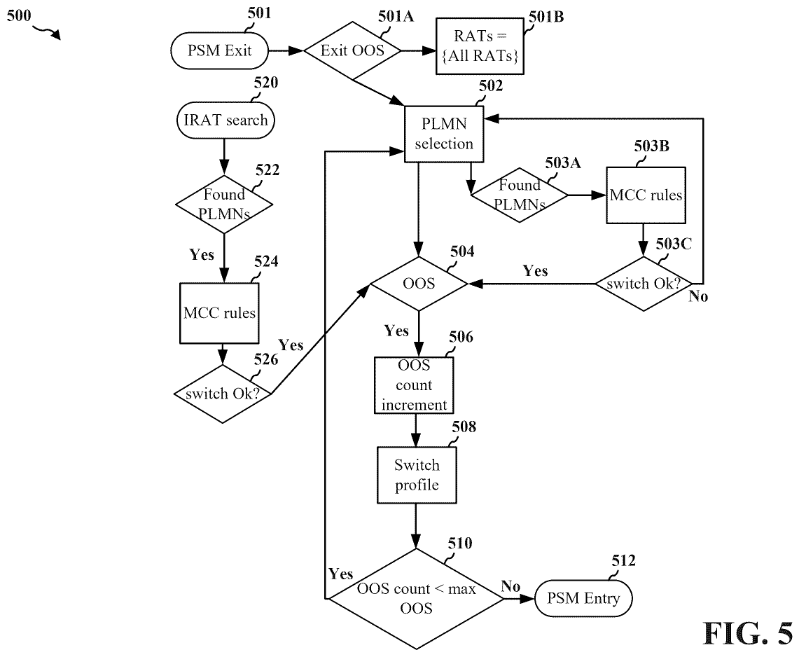

FIG. 5 is a diagram 500 illustrating example procedures for SIM switch where MCC based rules may be used, in accordance with various aspects of the present disclosure. As illustrated in FIG. 5, the UE may exit a power saving mode (PSM) at 501 and may exit OOS at 501A. At 501B, the UE may perform a search based on all RATs based on one or more conditions being met (e.g., based on the UE being OOS for a period of time longer than a threshold or based on a no-service counter that counts the number of OOS occurrences that may be maintained per SIM profile across PSM s or online cycles). The UE may perform PLM N selection at 502. If the UE is able to find a PLMN at 503A, at 503B, the UE may check the found PLM N(s) and associated MCCs based on a set of MCC rules to determine whether the UE may switch (e.g., at 503C) the SIM profile. If the UE determines that the UE may switch the SIM profile, the UE may go OOS at 504. If the UE determines that the UE may not switch the SIM profile, the UE may (re-)perform PLM N selection (502). If the UE is not able to find PLMN(s), the UE may be OOS at 504. In some aspects, as a UE performs IRAT search at 520, the UE may determine whether it could find PLM N at 45222. If the UE could find PLMN at 522, at 524, the UE may check the found PLMN(s) and associated MCCs based on a set of MCC rules to determine whether the UE may switch (e.g., at 526) the SIM profile. If the UE determines that the UE may switch the SIM profile, the UE may go OOS at 504.

If the UE is out of service at 504, at 506, the UE may increase a OOS counter and perform a SIM switch at 508. If the number of OOS counted based on the OOS counter is smaller than a maximum OOS threshold at 510, the UE may enter PSM at 512. If the number of OOS counted based on the OOS counter is not smaller than a maximum OOS threshold at 510, the UE may (re-)perform PLMN selection (502). In some aspects, a UE may be configured with different priorities with regard to each RAT of each SIM profile associated with the UE. As an example, the UE may have a EU1 SIM profile with a CA™/G RAT capability, a EU2 SIM profile with an NB/G RAT capability, and a EU3 SIM profile with NTN RAT capability. Each RAT may be associated with a priority, and the UE may maintain a timer that tracks how long the UE has been camping on low priority RATs (such as NB or GSM), which may be referred to as a cellular IoT (CloT) IRAT timer. When the UE is camped on a low priority RAT, the CloT IRAT timer may start. In some wireless communication systems, after CloT IRAT timer expiry, the UE may start searching for high priority RAT available in the current SIM profile that the UE is using. For example, if a UE is camped on EU1 GSM, the UE does not search for NB which is high priority RAT than GSM. If a UE is camped on EU2 GSM, the UE does not search for CA™ which is a higher priority RAT NB/GSM. If UE is camped on EU2 NB, the UE does not search for CA™ which is a higher priority RAT than NB. If the UE is camped on EU3 NTN, the UE does not start the CloT IRAT timer.

To improve efficiency, in some aspects, the UE may instead perform a search differently after CloT IRAT timer expiry based on priority of RATs across all SIM profiles. For example, if the UE is on low priority RAT G with EU1 profile which has CA™/G and CloT IRAT search timer expired, the UE may search for high priority RAT CA™ in a EU1 profile where the UE is latched. Next the UE may switch to a RAT under a different profile, such as SIM profile EU2 and may search for priority RAT NB in that the SIM profile EU2. Therefore, the UE may be on high priority RAT of any SIM profile if such high priority RAT is available. After searching for all high priority RATs, then the UE may be switched to low priority RATs associated with the previously active SIM profile EU1 and move to the next PSM Cycle. In other words, the UE would be on high priority RAT, regardless of whether it's associated with the previously active SIM profile, if the high priority RAT is available.

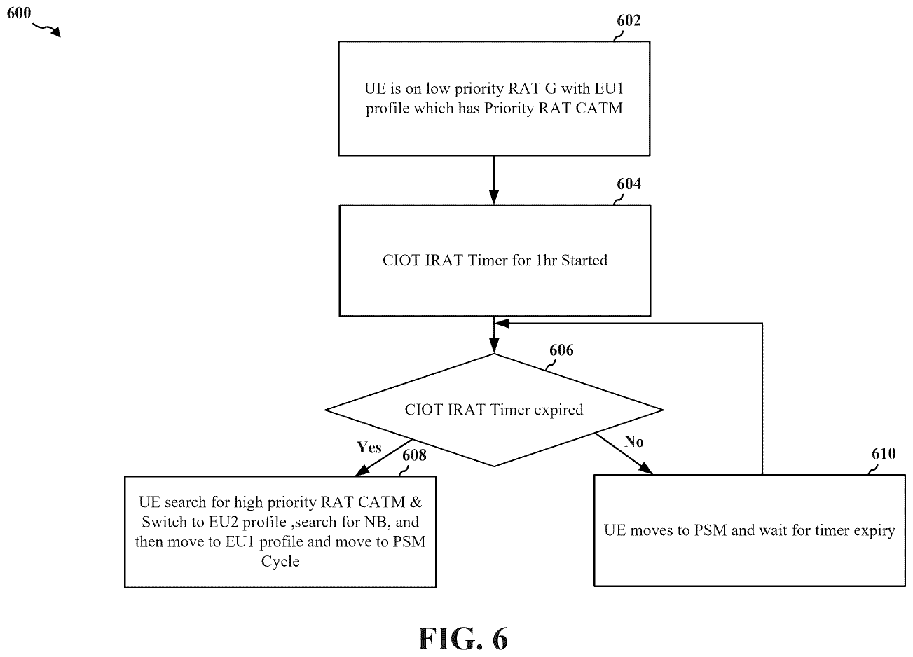

FIG. 6 is a diagram 600 illustrating example procedures for SIM switch where different RATs may have different priorities, in accordance with various aspects of the present disclosure. As illustrated in FIG. 6, at 602, the UE is on a (e.g., using or communicating based on a) low priority RAT G with an EU1 profile which has a high priority RAT CA™. A CloT IRAT search timer (e.g., for one hour) may start at 604. If the CloT IRAT search timer has expired at 606, at 608, the UE may search for high priority RAT CA™ and switch to EU2 SIM profile, search for NB (if the high priority RAT CA™ is not available), and then move to EU1 SIM profile and move to PSM cycle (if the high priority RAT CA™ and NB are not available). If the high priority RAT CA™ is found, the UE may communicate with the network based on the high priority RAT CA™. If the medium priority NB is found, the UE may communicate with the network based on the NB. If the CloT IRAT search timer has not expired at 606, at 610, the UE may move to PSM and wait for expiry of the CloT IRAT search timer.

In some aspects, when the UE is on low priority RAT G with EU2 profile which has NB/G, and the CloT IRAT search timer has expired, the UE may first search for high priority RAT NB in a EU2 profile where UE is latched. If the high priority RAT NB in a EU2 profile where UE is latched is not found, the UE may switch to other SIM profile (e.g., EU1) and may search for priority RAT CA™ in the EU1 SIM profile. Therefore, the UE may be on high priority RAT of any SIM profile if such high priority RAT is available. After searching for all high priority RATs, then the UE may be switched to low priority RATs associated with the previously active SIM profile EU2 and move to the next PSM Cycle. In other words, the UE would be on high priority RAT, regardless of whether it's associated with the previously active SIM profile, if the high priority RAT is available.

In some aspects, when the UE is on low priority RAT G with either EU1 or EU2 profile which has NB/G, and the CloT IRAT search timer has expired, the UE may first search for high priority RAT NB in a EU1 or EU2 profile where UE is latched. If the high priority RAT NB in the EU1 or EU2 profile where UE is latched is not found, the UE may switch to other SIM profile (e.g., EU1 or EU2) and may search for priority RAT CA™ in the EU1 SIM profile. Therefore, the UE may be on high priority RAT of any SIM profile if such high priority RAT is available. After searching for all high priority RATs, then the UE may be switched to low priority RATs associated with the previously active SIM profile and move to the next PSM Cycle. In other words, the UE would be on high priority RAT, regardless of whether it's associated with the previously active SIM profile, if the high priority RAT is available.

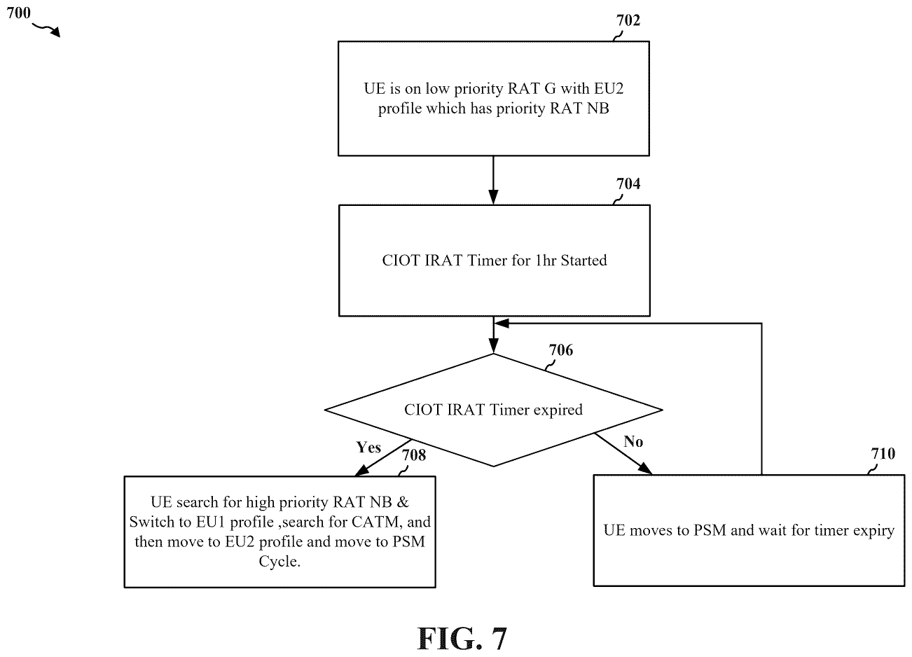

FIG. 7 is a diagram 700 illustrating example procedures for SIM switch where different RATs may have different priorities, in accordance with various aspects of the present disclosure. As illustrated in FIG. 7, at 702, the UE is on low priority RAT G with an EU2 profile which has high priority RAT NB. A CloT IRAT search timer (e.g., for one hour) may start at 704. If the CloT IRAT search timer has expired at 706, at 708, the UE may search for high priority NB and switch to EU1 SIM profile, search for RAT CA™ (if the high priority NB is not available), and then move to the EU2 SIM profile and move to PSM cycle (if the high priority RAT CA™ and NB are not available). If the high priority NB is found, the UE may communicate with the network based on the NB. If the high priority RAT CA™ is found, the UE may communicate with the network based on the high priority RAT CA™. If the CloT IRAT search timer has not expired at 706, at 710, the UE may move to PSM and wait for expiry of the CloT IRAT search timer.

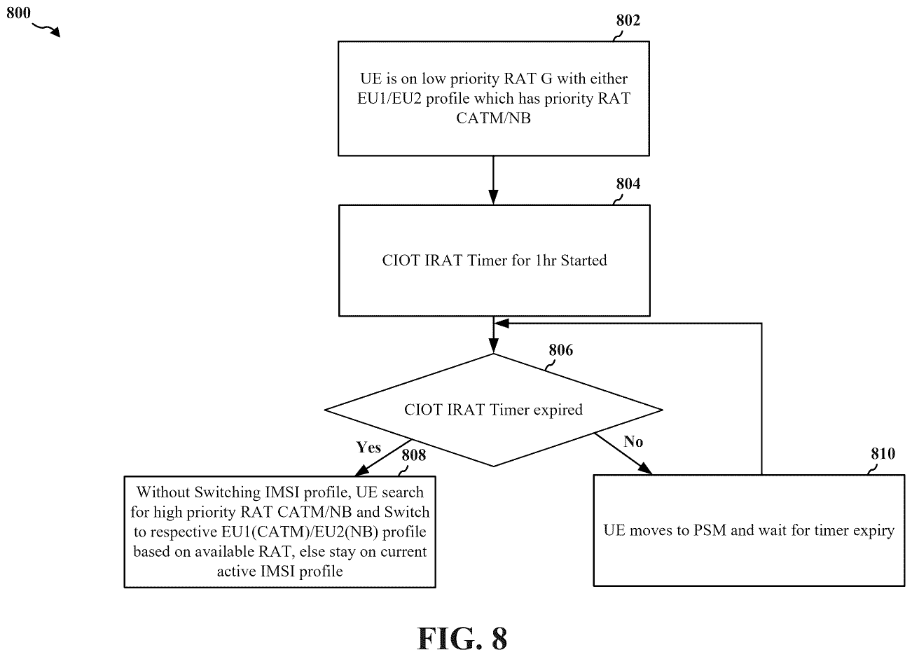

FIG. 8 is a diagram 800 illustrating example procedures for SIM switch where different RATs may have different priorities, in accordance with various aspects of the present disclosure. As illustrated in FIG. 8, at 802, the UE is on a low priority RAT G with an EU1/EU2 profile which has high priority RAT CA™/NB. A CloT IRAT search timer (e.g., for one hour) may start at 804. If the CloT IRAT search timer has expired at 806, at 808, the UE may search for high priority CA™/NB and switch SIM profile based on available high priority RAT or stay on a currently active SIM profile (if no other high priority RAT is available). If a high priority RAT is found, the UE may communicate with the network based on the high priority RAT. If the CloT IRAT search timer has not expired at 806, at 810, the UE may move to PSM and wait for expiry of the CloT IRAT search timer.

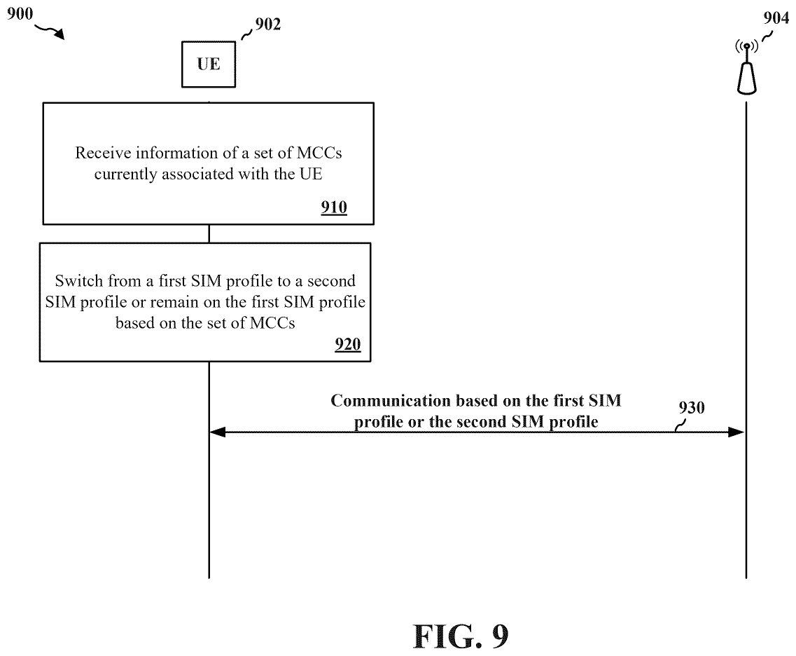

FIG. 9 is a diagram 900 illustrating example communications between a network node 904 and a UE 902, in accordance with various aspects of the present disclosure. In some aspects, the UE may, at 910, receive (e.g., based on performing an IRAT search) information of a set of MCCs currently associated with the UE. The UE may be configured with (e.g., based on signaling from a network node, or without signaling from the network node and stored at the UE) MCC based rules that maps at least one SIM profile to one or more MCCs or one or more combinations of MCCs (e.g., in the form of a table), where the at least one SIM profile may be switched to (or stayed on) if the mapped MCC(s) are detected. At 920, the UE 902 may switch from a first SIM profile to a second SIM profile or remain on the first SIM profile based on the set of MCCs. At 930, the UE 902 may communicate with the network node 904 based on the second SIM profile that the UE switched to or the first SIM profile that the UE stayed on.

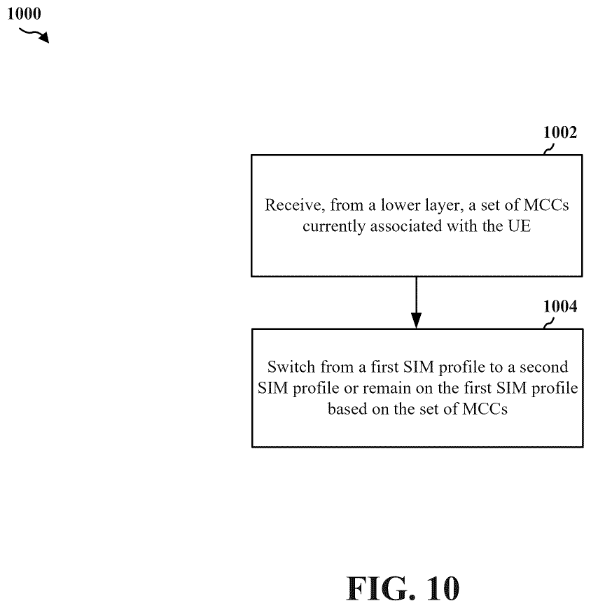

FIG. 10 is a flowchart 1000 of a method of wireless communication. The method may be performed by a UE (e.g., the UE 104, the UE 902; the apparatus 1204). The method provides mechanisms for SIM profile switching that may be more suited for a device that may be travelling for a long distance.

At 1002, the UE may receive, from a lower layer, a set of MCCs currently associated with the UE. For example, the UE 902 may receive (e.g., at 910), from a lower layer, a set of MCCs currently associated with the UE. In some aspects, 1002 may be performed by SIM component 198.

At 1004, the UE may switch from a first SIM profile to a second SIM profile or remain on the first SIM profile based on the set of MCCs. For example, the UE 902 may (e.g., at 920) switch from a first SIM profile to a second SIM profile or remain on the first SIM profile based on the set of MCCs. In some aspects, 1004 may be performed by SIM component 198.

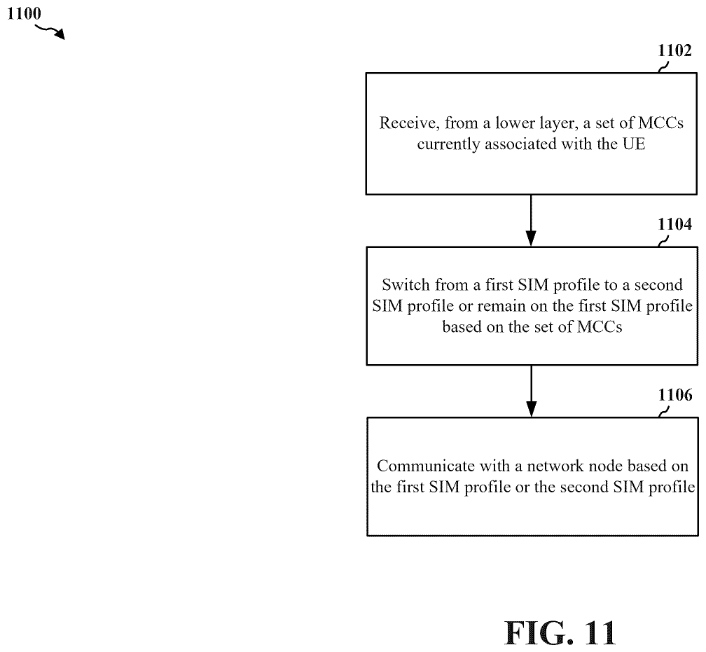

FIG. 11 is a flowchart 1100 of a method of wireless communication. The method may be performed by a UE (e.g., the UE 104, the UE 902; the apparatus 1204). The method provides mechanisms for SIM profile switching that may be more suited for a device that may be travelling for a long distance.

At 1102, the UE may receive, from a lower layer, a set of MCCs currently associated with the UE. For example, the UE 902 may receive (e.g., at 910), from a lower layer, a set of MCCs currently associated with the UE. In some aspects, 1102 may be performed by SIM component 198.

At 1104, the UE may switch from a first SIM profile to a second SIM profile or remain on the first SIM profile based on the set of MCCs. For example, the UE 902 may (e.g., at 920) switch from a first SIM profile to a second SIM profile or remain on the first SIM profile based on the set of MCCs. In some aspects, 1104 may be performed by SIM component 198.

In some aspects, the UE may determine that at least one MCC of the set of MCCs is associated with a public land mobile network (PLMN) associated with a region associated with the second SIM profile without being associated with the first SIM profile. In some aspects, the UE may perform a radio access technology (RAT) search with an extended scope based on being out of service (OOS) for a period of time longer than a threshold or based on a movement of the UE. In some aspects, the UE may perform a radio access technology (RAT) search with an extended scope based on a cumulative counter of out of service (OOS) occurrence being larger than a threshold.

In some aspects, the UE may determine whether to switch from the first SIM profile to the second SIM profile based on at least one table that maps a first set of combinations of MCCs to the first SIM profile and a second set of combinations of MCCs to the second SIM profile. In some aspects, the at least one table is maintained per SIM profile.

In some aspects, the UE may perform a search for, based on the UE being operating based on a low priority radio access technology (RAT) for a period of time longer than a threshold, a first RAT associated with the first SIM profile or the second SIM profile, where the first RAT is defined to have a highest priority. In some aspects, based on the search being successful, the UE may switch to the first RAT. In some aspects, based on the search being unsuccessful, the UE may stay on the low priority RAT. In some aspects, based on the search being unsuccessful, the UE may perform a second search for a second RAT associated with the first SIM profile or the second SIM profile, where the second RAT is defined to have a second highest priority. In some aspects, based on the second search being successful, the UE may switch to the second RAT. In some aspects, based on the second search being unsuccessful and based on a lack of a higher priority RAT compared to the low priority RAT other than the first RAT and the second RAT, the UE may stay on the low priority RAT.

At 1106, the UE may communicate with a network node based on the first SIM profile or the second SIM profile. For example, the UE 902 may communicate (e.g., 930) with a network node (e.g., 904) based on the first SIM profile or the second SIM profile. In some aspects, 1106 may be performed by SIM component 198.

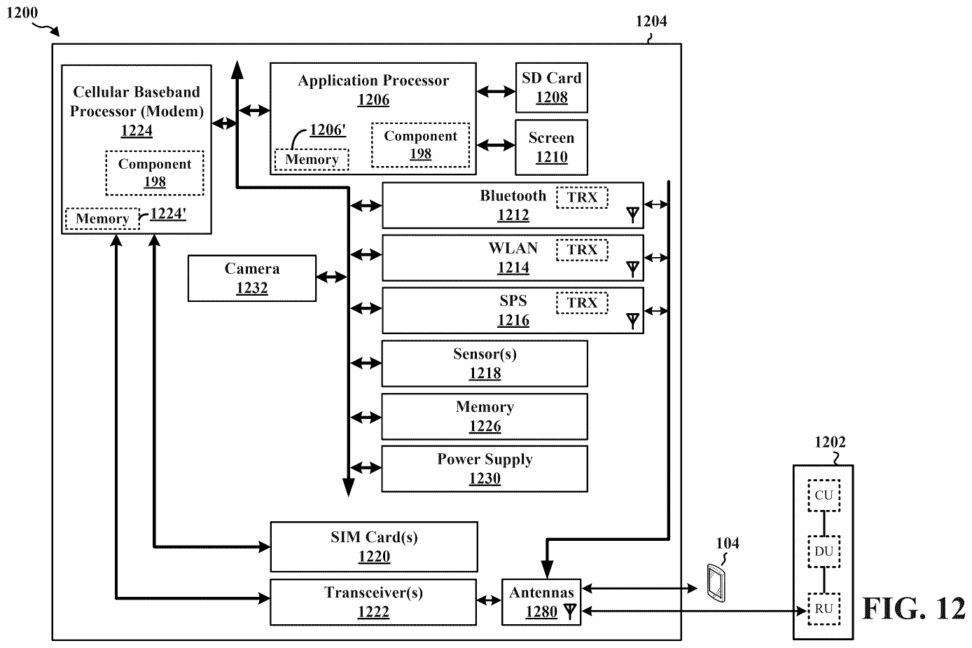

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include at least one cellular baseband processor 1224 (also referred to as a modem) coupled to one or more transceivers 1222 (e.g., cellular RF transceiver). The cellular baseband processor(s) 1224 may include at least one on-chip memory 1224′. In some aspects, the apparatus 1204 may further include one or more subscriber identity modules (SIM) cards 1220 and at least one application processor 1206 coupled to a secure digital (SD) card 1208 and a screen 1210. The application processor(s) 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor(s) 1224 communicates through the transceiver(s) 1222 via one or more antennas 1280 with the UE 104 and/or with an RU associated with a network entity 1202. The cellular baseband processor(s) 1224 and the application processor(s) 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor(s) 1224 and the application processor(s) 1206 are each responsible for general processing, including the execution of software stored on the computer-readable medium/memory. The software, when executed by the cellular baseband processor(s) 1224/application processor(s) 1206, causes the cellular baseband processor(s) 1224/application processor(s) 1206 to perform the various functions described supra. The computer-readable medium/memory may also be used for storing data that is manipulated by the cellular baseband processor(s) 1224/application processor(s) 1206 when executing software. The cellular baseband processor(s) 1224/application processor(s) 1206 may be a component of the UE 350 and may include the at least one memory 360 and/or at least one of the TX processor 368, the RX processor 356, and the controller/processor 359. In one configuration, the apparatus 1204 may be at least one processor chip (modem and/or application) and include just the cellular baseband processor(s) 1224 and/or the application processor(s) 1206, and in another configuration, the apparatus 1204 may be the entire UE (e.g., see UE 350 of FIG. 3) and include the additional modules of the apparatus 1204.

As discussed supra, the SIM component 198 may be configured to receive, from a lower layer, a set of mobile country codes (MCCs) currently associated with the UE. In some aspects, the SIM component 198 may be further configured to switch from a first SIM profile to a second SIM profile or remain on the first SIM profile based on the set of MCCs. The SIM component 198 may be within the cellular baseband processor(s) 1224, the application processor(s) 1206, or both the cellular baseband processor(s) 1224 and the application processor(s) 1206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1204 may include a variety of components configured for various functions. In one configuration, the apparatus 1204, and in particular the cellular baseband processor(s) 1224 and/or the application processor(s) 1206, may include means for receiving, from a lower layer, a set of MCCs currently associated with the UE. In some aspects, the apparatus 1204 may include means for switching from a first SIM profile to a second SIM profile or remaining on the first SIM profile based on the set of MCCs. In some aspects, the apparatus 1204 may include means for determining that at least one MCC of the set of MCCs is associated with a public land mobile network (PLMN) associated with a region associated with the second SIM profile without being associated with the first SIM profile. In some aspects, the apparatus 1204 may include means for performing a radio access technology (RAT) search with an extended scope based on being out of service (OOS) for a period of time longer than a threshold or based on a movement of the UE. In some aspects, the apparatus 1204 may include means for performing a radio access technology (RAT) search with an extended scope based on a cumulative counter of out of service (OOS) occurrence being larger than a threshold. In some aspects, the apparatus 1204 may include means for determining whether to switch from the first SIM profile to the second SIM profile based on at least one table that maps a first set of combinations of MCCs to the first SIM profile and a second set of combinations of MCCs to the second SIM profile. In some aspects, the apparatus 1204 may include means for performing a search for, based on the UE being operating based on a low priority radio access technology (RAT) for a period of time longer than a threshold, a first RAT associated with the first SIM profile or the second SIM profile, where the first RAT is defined to have a highest priority. In some aspects, the apparatus 1204 may include means for switching to the first RAT based on the search being successful. In some aspects, the apparatus 1204 may include means for staying on the low priority RAT based on the search being unsuccessful. In some aspects, the apparatus 1204 may include means for performing a second search for a second RAT associated with the first SIM profile or the second SIM profile based on the search being unsuccessful, where the second RAT is defined to have a second highest priority. In some aspects, the apparatus 1204 may include means for switching to the second RAT based on the second search being successful. In some aspects, the apparatus 1204 may include means for staying on the low priority RAT. In some aspects, the apparatus 1204 may include means for communicating with a network node based on the first SIM profile or the second SIM profile based on the second search being unsuccessful and based on a lack of a higher priority RAT compared to the low priority RAT other than the first RAT and the second RAT. The means may be the component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for wireless communication at a user equipment (UE), including: at least one memory; and at least one processor coupled to the at least one memory, and based at least in part on information stored in the at least one memory, the at least one processor is configured to: receive, from a lower layer, a set of MCCs currently associated with the UE; and switch from a first SIM profile to a second SIM profile or remain on the first SIM profile based on the set of MCCs.

Aspect 2 is the apparatus of aspect 1, where to switch from the first SIM profile to the second SIM profile, the at least one processor is configured to: determine that at least one MCC of the set of MCCs is associated with a public land mobile network (PLMN) associated with a region associated with the second SIM profile without being associated with the first SIM profile.

Aspect 3 is the apparatus of any of aspects 1-2, where the at least one processor is further configured to: perform a radio access technology (RAT) search with an extended scope based on being out of service (OOS) for a period of time longer than a threshold or based on a movement of the UE.

Aspect 4 is the apparatus of any of aspects 1-3, where the at least one processor is further configured to: perform a radio access technology (RAT) search with an extended scope based on a cumulative counter of out of service (OOS) occurrence being larger than a threshold.

Aspect 5 is the apparatus of any of aspects 1-4, where the at least one processor is further configured to: determine whether to switch from the first SIM profile to the second SIM profile based on at least one table that maps a first set of combinations of MCCs to the first SIM profile and a second set of combinations of MCCs to the second SIM profile.

Aspect 6 is the apparatus of aspect 5, where the at least one table is maintained per SIM profile.

Aspect 7 is the apparatus of any of aspects 1-6, where the at least one processor is further configured to: perform a search for, based on the UE being operating based on a low priority radio access technology (RAT) for a period of time longer than a threshold, a first RAT associated with the first SIM profile or the second SIM profile, where the first RAT is defined to have a highest priority.

Aspect 8 is the apparatus of aspect 7, where the at least one processor is further configured to: based on the search being successful, switch to the first RAT.

Aspect 9 is the apparatus of any of aspects 7-8, where the at least one processor is further configured to: based on the search being unsuccessful, stay on the low priority RAT.

Aspect 10 is the apparatus of any of aspects 7-9, where the at least one processor is further configured to: based on the search being unsuccessful, perform a second search for a second RAT associated with the first SIM profile or the second SIM profile, where the second RAT is defined to have a second highest priority.

Aspect 11 is the apparatus of aspect 10, where the at least one processor is further configured to: based on the second search being successful, switch to the second RAT.

Aspect 12 is the apparatus of any of aspects 10-11, where the at least one processor is further configured to: based on the second search being unsuccessful and based on a lack of a higher priority RAT compared to the low priority RAT other than the first RAT and the second RAT, stay on the low priority RAT.

Aspect 13 is the apparatus of any of aspects 1-12, where the at least one processor is further configured to: communicate with a network node based on the first SIM profile or the second SIM profile.

Aspect 14 is a method of wireless communication for implementing any of aspects 1 to 13.

Aspect 15 is a computer-readable medium (e.g., a non-transitory computer-readable medium) storing computer executable code, the code when executed by at least one processor causes the at least one processor to implement any of aspects 1 to 13.

Aspect 16 is an apparatus comprising means for implementing any of aspects 1 to 13.

What is claimed is:

1. An apparatus for wireless communication at a user equipment (UE), comprising:
at least one memory; and
at least one processor coupled to the at least one memory, and based at least in part on information stored in the at least one memory, the at least one processor is configured to:
receive, from a lower layer, a set of mobile country codes (MCCs) currently associated with the UE; and
switch from a first subscriber identity module (SIM) profile to a second SIM profile or remain on the first SIM profile based on the set of MCCs.

2. The apparatus of claim 1, wherein the switch from the first SIM profile to the second SIM profile is based on a determination that at least one MCC of the set of MCCs is associated with a public land mobile network (PLMN) associated with a region associated with the second SIM profile without being associated with the first SIM profile.

3. The apparatus of claim 1, wherein the at least one processor is further configured to:
perform a radio access technology (RAT) search with an extended scope based on being out of service (OOS) for a period of time longer than a threshold or based on a movement of the UE.

4. The apparatus of claim 1, wherein the at least one processor is further configured to:
perform a radio access technology (RAT) search with an extended scope based on a cumulative counter of out of service (OOS) occurrence being larger than a threshold.

5. The apparatus of claim 1, wherein the at least one processor is further configured to:
determine whether to switch from the first SIM profile to the second SIM profile based on at least one table that maps a first set of combinations of MCCs to the first SIM profile and a second set of combinations of MCCs to the second SIM profile.

6. The apparatus of claim 5, wherein the at least one table is maintained per SIM profile.

7. The apparatus of claim 1, wherein the at least one processor is further configured to:
perform, based on the UE being operating based on a low priority radio access technology (RAT) for a period of time longer than a threshold, a search for a first RAT associated with the first SIM profile or the second SIM profile, wherein the first RAT is defined to have a highest priority.

8. The apparatus of claim 7, wherein the at least one processor is further configured to:
switch to the first RAT based on the search being successful.

9. The apparatus of claim 7, wherein the at least one processor is further configured to:
stay on the low priority RAT based on the search being unsuccessful.

10. The apparatus of claim 7, wherein the at least one processor is further configured to:
perform, based on the search being unsuccessful, a second search for a second RAT associated with the first SIM profile or the second SIM profile, wherein the second RAT is defined to have a second highest priority.

11. The apparatus of claim 10, wherein the at least one processor is further configured to:
switch to the second RAT, based on the second search being successful.

12. The apparatus of claim 10, wherein the at least one processor is further configured to:
stay on the low priority RAT based on the second search being unsuccessful and based on a lack of a higher priority RAT compared to the low priority RAT other than the first RAT and the second RAT.

13. The apparatus of claim 1, wherein the at least one processor is further configured to:
communicate with a network node based on the first SIM profile or the second SIM profile.

14. A method for wireless communication performed by a user equipment (UE), comprising:
receiving, from a lower layer, a set of mobile country codes (MCCs) currently associated with the UE; and
switching from a first subscriber identity module (SIM) profile to a second SIM profile or remaining on the first SIM profile based on the set of MCCs.

15. The method of claim 14, wherein switching from the first SIM profile to the second SIM profile comprises:
determining that at least one MCC of the set of MCCs is associated with a public land mobile network (PLMN) associated with a region associated with the second SIM profile without being associated with the first SIM profile.

16. The method of claim 14, further comprising:
performing a radio access technology (RAT) search with an extended scope based on being out of service (OOS) for a period of time longer than a threshold or based on a movement of the UE.

17. The method of claim 14, further comprising:
performing a radio access technology (RAT) search with an extended scope based on a cumulative counter of out of service (OOS) occurrence being larger than a threshold.

18. The method of claim 14, further comprising:
determining whether to switch from the first SIM profile to the second SIM profile based on at least one table that maps a first set of combinations of MCCs to the first SIM profile and a second set of combinations of MCCs to the second SIM profile.

19. The method of claim 14, further comprising:
performing a search for, based on the UE being operating based on a low priority radio access technology (RAT) for a period of time longer than a threshold, a first RAT associated with the first SIM profile or the second SIM profile, wherein the first RAT is defined to have a highest priority.

20. The method of claim 14, further comprising:
communicating with a network node based on the first SIM profile or the second SIM profile.
